(19) United States
(12) Patent Application Publication
(10) Pub. No.: US 2010/0168663 A1
(43) Pub. Date: Jul. 1, 2010

(54) DEVICE FOR THE ORAL ADMINISTRATION OF ACTIVE INGREDIENTS

(75) Inventor: Marc Maury, Saint Medard en Jalles (FR)

Correspondence Address: YOUNG & THOMPSON, 209 Madison Street, Suite 500, Alexandria, VA, 22314, US

(73) Assignee: UNITHER DEVELOPPEMENT, Amiens (FR)

(21) Appl. No.: 12/676,153

(22) PCT Filed: Sep. 5, 2008
(86) PCT No.: PCT/FR08/51590

§ 371 Date: Mar. 3, 2010

(30) Foreign Application Priority Data
Sep. 5, 2007 (FR) 07 57364

(51) Int. Cl. A61J 7/00

(52) U.S. Cl. 604/77

(57) ABSTRACT

A device (10) for oral administration of medications that comes in the form of an elongated tubular body includes an element (12, 14) that can enable a liquid to enter or exit at each end, a nonreturn valve (16) at one of the two ends, and at least one substrate (18) that consists of at least one neutral substrate (20) and a soluble coating layer (22) that has a different coloring from that of the neutral substrate and that contains at least one active ingredient.

This invention relates to a device for the oral administration of medications, making it possible to demonstrate the taking of dispensed medications.

The taking of medications by children and the elderly poses numerous problems.

Actually, it is extremely difficult to administer conventional solid pharmaceutical forms such as tablets or capsules to them by oral ingestion.

Furthermore, whereas the liquid forms such as syrups or oral solutions are easier to use, they also have significant technical drawbacks.

First of all, numerous active ingredients cannot be offered in liquid form due to problems of solubility, stability, or taste. The stability of medications offered in liquid form is often difficult to control because the processes of degradation and hydrolysis are greatly increased in the presence of water.

In addition, the formulation of a liquid pharmaceutical product generally requires the use of anti-microbial preservatives that are difficult to control and that impart unpleasant and residual tastes.

In addition, to ensure that the patient indeed takes the dose of medication, it is necessary to reduce as much as possible the volume of solution that is delivered. Conventionally, the volume of solution for an adult is close to 15 ml, which corresponds to a tablespoon, and for a child, the volume is 5 ml, or the equivalent of a teaspoon. However, with so small a volume, it is difficult to control the dissolution of the active ingredients as well as the taste of the preparation. It is possible in particular to cite the case of ibuprofen- or paracetamol-based preparations that are often offered in aqueous suspension form whose physico-chemical stability is faulted because of recrystallization problems.

For all of these reasons, despite their obvious advantage for the patients, the liquid pharmaceutical forms for oral use are not satisfactory.

So as to remedy the problems of formulations of certain pharmaceutical forms for oral use, there are solid pharmaceutical forms that have to be solubilized before ingestion by the patients. This is the case, for example, of effervescent tablets that make it possible, to a certain extent, to have both the advantages of stability of the solid pharmaceutical forms and the ease of taking a liquid pharmaceutical form.

However, these pharmaceutical forms are not universal and also have specific constraints. In the case of effervescent forms, the formulation comprises a large quantity of sodium (sodium carbonate or bicarbonate) that makes their use not very relevant in the elderly who are suffering from high blood pressure. In contrast, the dissolution of the tablet usually takes several minutes, a period of time that is often considered too long by the patient.

There is therefore a need for a system that allows easy dispensing of the medications in liquid form, particularly suitable for the elderly and children and not having the drawbacks of known and commonly used liquid and solid forms.

To respond to this, this invention proposes using a particular medication-dispensing system that comprises a partially soluble substrate that contains at least one active ingredient that can change color when the entire active ingredient has been effectively dissolved and absorbed by the patient.

Devices for dispensing molecules, in particular in the form of straws that comprise soluble dry granules, are known. It is possible to cite in particular the patent applications WO-03/101,226 and U.S. Pat. No. 5,718,681 that describe delivery systems that come in the form of straws that allow absorption of granules by sucking up a liquid.

These devices, however, although acceptable for agricultural use, are not suitable for the administration of medications.

First of all, they do not make it possible to characterize the dispensing of the medication to the patient in a simple manner.

In addition, when the user drinks through the straw, he is physiologically forced to stop sucking in the liquid to start breathing again. The liquid that is contained in the straw goes down spontaneously by gravity into the glass that contains the dissolution liquid, which causes a possible loss of the product to be ingested that is contained in the straw. It is then impossible to determine precisely the fraction of product ingested by the user.

This invention therefore has as its objective to remedy the drawbacks and insufficiencies of the prior art.

For this purpose, the object of the invention is a device for oral administration of medications that comes in the form of an elongated tubular body, comprising means that can enable a liquid to enter or exit at each end, a nonreturn valve at one of the two ends and at least one substrate that consists of at least one neutral substrate and a soluble coating layer that contains at least one active ingredient and that has a different coloring from that of the neutral substrate.

Active ingredient is defined as any substance that has pharmacodynamic or therapeutic properties, including probiotic bacteria.

Substrate is defined as any solid element that comprises vehicles and one or more active ingredient(s) that are designed to be dissolved in a liquid. It consists of at least one neutral substrate on which at least one soluble coating layer is placed. It can come, for example, in the form of a tablet, a particle, an agglomerate obtained by compacting, a ball, etc.

Coating layer is defined as any water-soluble pharmaceutical composition that is located above or around a neutral substrate, comprising at least one active ingredient. The coating layer is designed to be gulped down by the patient once it is dissolved in a liquid. It is, for example, a lamination, a sugar-coating, or an agglomerate layer.

Neutral substrate is defined as any insoluble or slightly water-soluble substrate that is able to accommodate one or more coating layer(s), lacking any active ingredient. It consists of a preferably inert material that cannot react with the medium or the active ingredients or pharmaceutical components that it receives. It can have, for example, a polymeric plastic structure and the capability of allowing both the homogenous and uniform setting of the coating layer just like its uniform and complete dissolution upon contact with a liquid. It comes, for example, in the form of a layer, particle or block.

The invention is now described in detail with regard to the accompanying drawings in which:

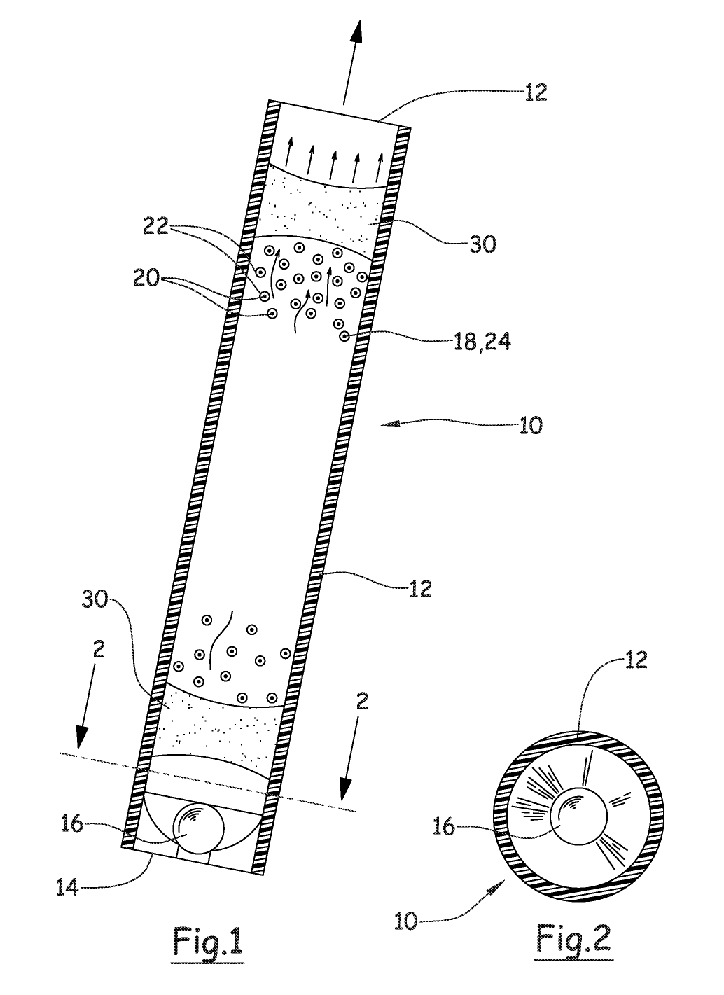

FIG. 1 shows a first embodiment of the device according to the invention, with substrates that come in the form of particles,

FIG. 2 shows a cutaway view of the device that is shown in FIG. 1 along line 2-2,

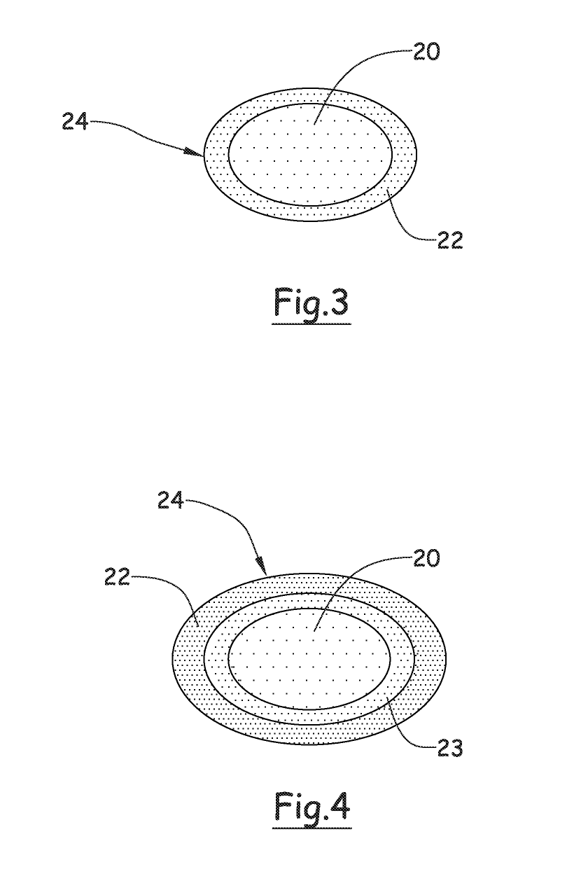

FIGS. 3 and 4 show two variants of a substrate in the form of particles,

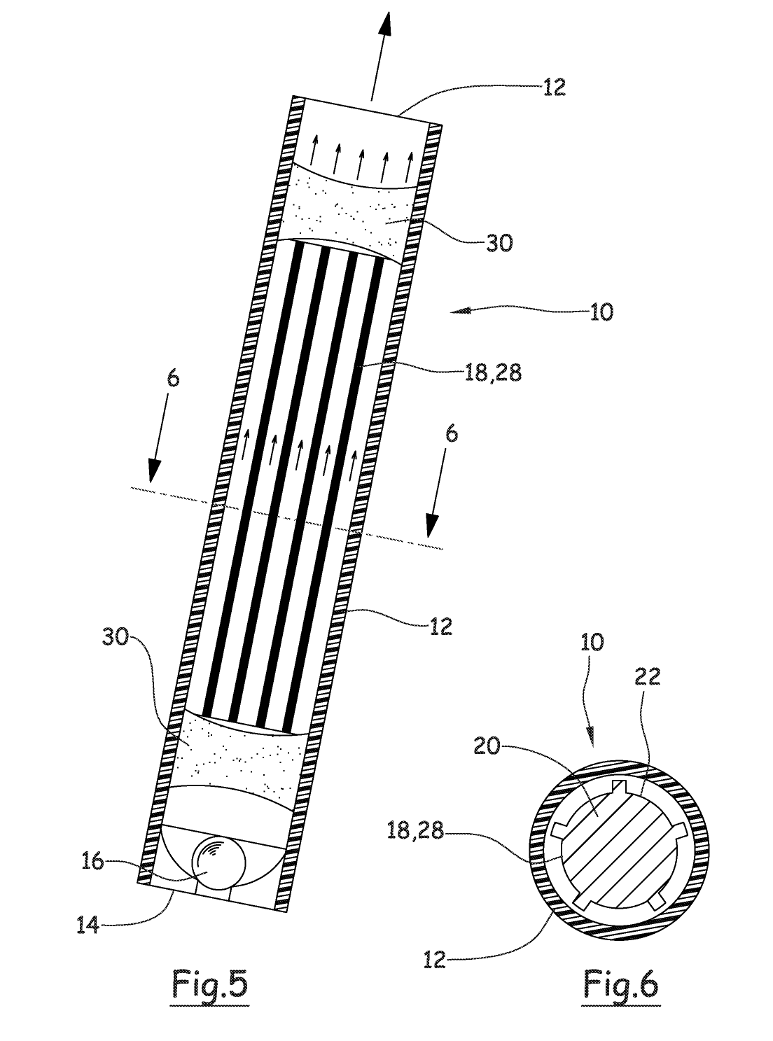

FIG. 5 shows a second embodiment of the device according to the invention with a substrate that comes in the form of an agglomerate,

FIG. 6 shows a cutaway view of the device that is shown in FIG. 5, along line 6-6,

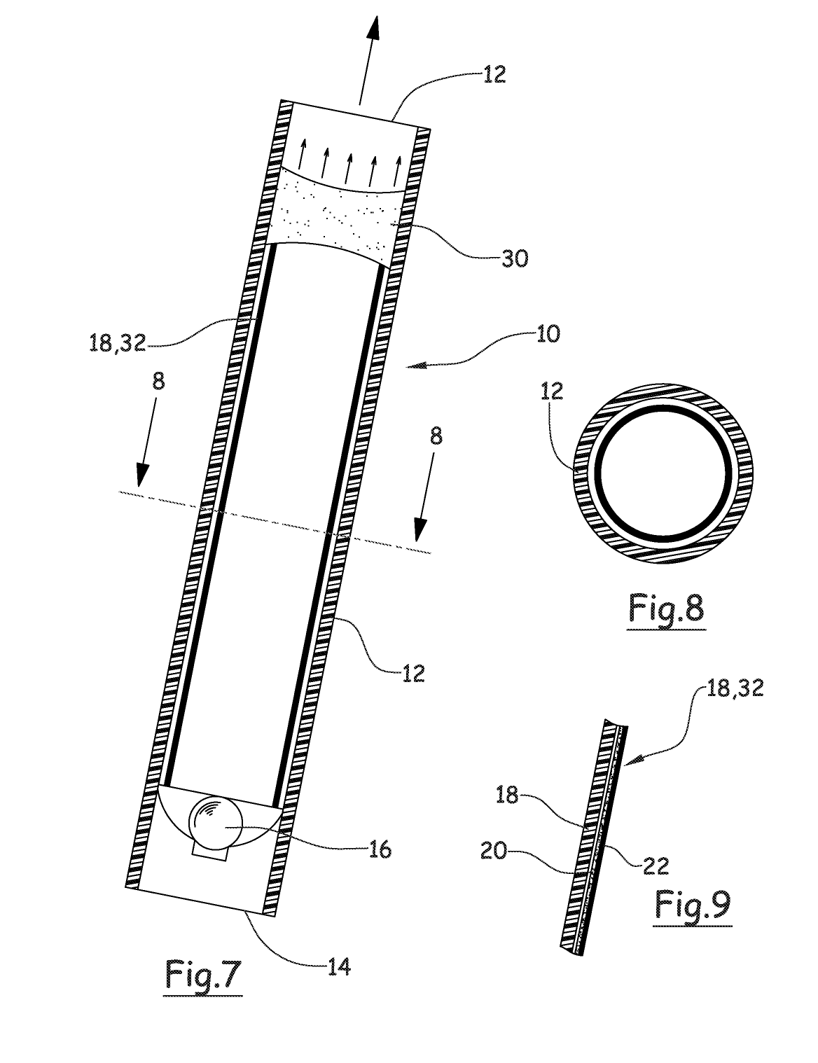

FIG. 7 shows a third embodiment of the device according to the invention with a substrate that is arranged on the walls of the device,

FIG. 8 shows a cutaway view of the device that is shown in FIG. 7, along line 8-8,

FIG. 9 shows an enlargement of the wall of the device that is shown in FIG. 7,

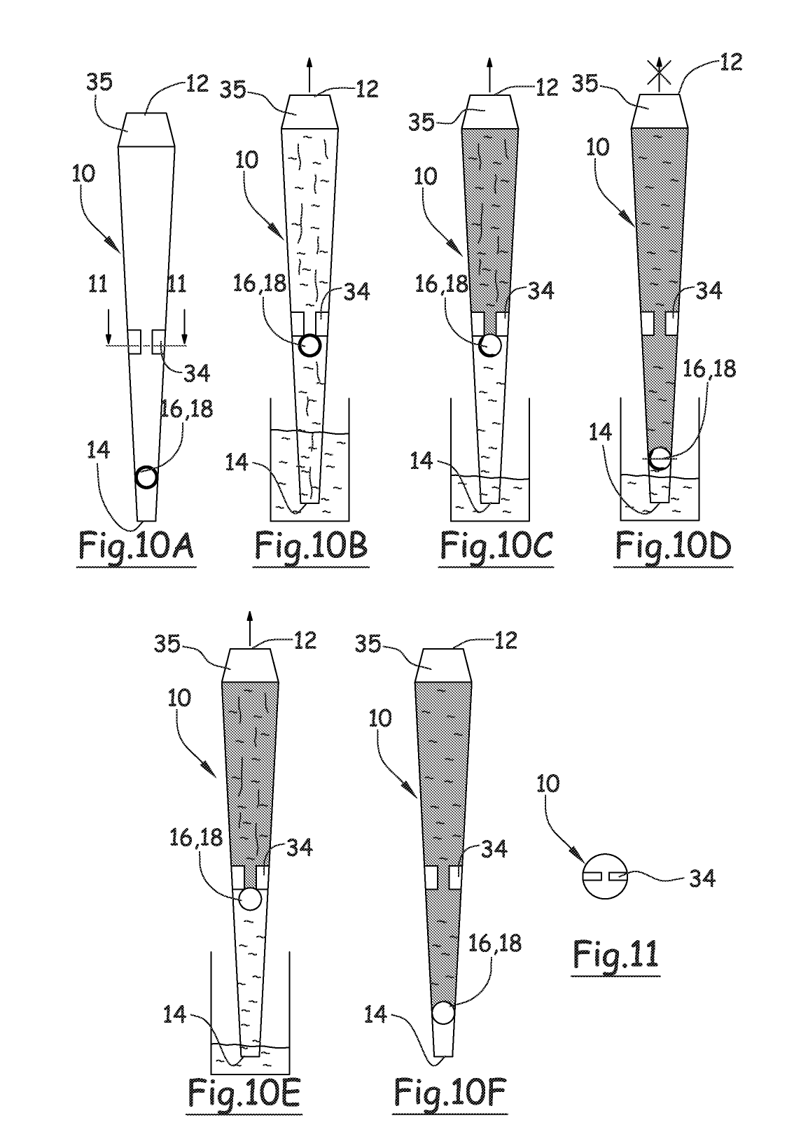

FIG. 10A shows a fourth embodiment of the device according to the invention,

FIGS. 10B to 10F show an operational block diagram of the variant of FIG. 10A of the device according to the invention,

FIG. 11, showing a cutaway view of the device shown in FIG. 10A, along line 11-11.

The purpose of the invention is therefore a device 10 for oral administration of medications, which comes in the form of an elongated tubular body, comprising means 12, 14 that can enable a liquid to enter or exit at each end, so as to pass through the volume, a nonreturn valve 16 at one of the two ends, and at least one substrate 18 that consists of at least one neutral substrate 20 and a soluble coating layer 22 that has a different coloring from that of the neutral substrate and that contains at least one active ingredient.

The nonreturn valve 16 can assume any suitable shape that makes it possible to keep a liquid in the device. The nonreturn valve 16 can assume, for example, the shape of a ball or a disk.

Preferably, the nonreturn valve 16 is a ball, preferably a ball made of dense material, lacking any buoyancy in an aqueous liquid.

The device 10 can also comprise locking means 34 of the nonreturn valve 16. It can be, for example, a return element that is connected to the valve, a stop that is arranged inside the tubular body or else an internal constriction of the tubular section of the device 10.

It can also comprise at least one insert 30 that is designed to keep the insoluble materials inside the straw. This insert 30 can come, for example, in the form of an open-pore foam or a grid.

According to another aspect, the device 10 can have a suction spout 35 at discharge means 12, making it possible to facilitate the application of the lips during the use of the device while making known precisely and spontaneously its terms and conditions for use to the user.

The device can also come in the form of an elongated tubular body with a section that decreases toward one of the two ends.

The substrate 18 that is contained in the device according to the invention consists of at least:
One neutral substrate 20, and
A soluble layer 22 that has a different coloring from that of the neutral substrate and that contains at least one active ingredient.

Several configurations are possible:
Either the substrate 20 is colorless, and the layer 22 is tinted,
Or the substrate 20 is tinted, and the outer layer 22 is tinted with a different color.

Preferably, the soluble outer layer 22 has a neutral coloring, for example, orange-yellow, and the substrate 20 has a green coloring.

The substrate 20 is neutral. It is either an insoluble substrate or a slightly water-soluble substrate on which an optionally tinted insoluble layer 23 that consists of, for example, a lacquer gum or another insoluble polymer such as ethyl cellulose is deposited.

In the case where the inner substrate 20 is insoluble, it can comprise a polyethylene or polypropylene plastic polymer, and an opacifying agent.

According to one variant, it can comprise balls of saccharide, polysaccharide, agar-agar-type gelling agent, alginate or starch, and an opacifying agent.

It can also be produced starting from a mixture of gelatin and glycerin, conventionally used for the gel capsules that come in the form of soft capsules. In the case where the substrate 20 is tinted, it also comprises a coloring agent. The outer layer 22 is soluble and comprises at least one active ingredient. According to a preferred embodiment, the outer layer 22 comprises:
A diluting agent, in particular selected from among soluble carbon hydrate polyols, such as sorbitol, mannitol, saccharose, lactose or fructose,
A soluble polymeric binding agent, such as a cellulose agent such as hydroxymethyl cellulose, hydroxypropylmethyl cellulose, methyl cellulose, polyvinyl alcohol,
Povidone, and
At least one active ingredient.

According to one variant, the soluble outer layer 22 also comprises a solubilizing agent, for example a surfactant such as sodium lauryl sulfate or an ester-type agent of fatty acid, such as, for example, “hydrogenated castor oil” and its derivatives, or else a component of the family of polysorbates.

The outer layer 22 can also comprise a sweetening agent and an aromatizing agent for improving the taste of the preparation after dissolution in the liquid that is absorbed by the patient.

In the case where the outer layer 22 is tinted, it also comprises a coloring agent. Preferably, this coloring agent comes in the form of a soluble dye or a pigment that is fixed on an aluminum lacquer.

According to a first embodiment of the invention shown in FIG. 1, the device 10 comprises several substrates 18.

Each substrate comes in the form of a particle 24 that comprises a neutral inner substrate 20, and at least one soluble outer coating layer 22 that contains at least one active ingredient and that has a different coloring from that of the neutral substrate 20.

Either the inner substrate 20 is colorless and the outer coating layer 22 is tinted, or the inner substrate 20 is tinted and the outer coating layer 22 is tinted with a different color.

According to a particularly suitable variant, shown in FIG. 4, the particle also comprises an insoluble layer 23 between the inner substrate 20 and the outer layer 22.

Preferably, the particles are between 0.8 and 4 mm in size.

The tinted particles 24 are manufactured and then arranged inside the tubular body, freely, in the form of a block or on the inner walls of the device, and when a liquid passes inside the device 10, the medicinal layer 22 is dissolved.

The particles can also be enclosed in a monolithic porous matrix, itself arranged inside the tubular body, so that when a liquid passes inside the device 10, the matrix retains the insoluble elements.

FIG. 5 shows a second embodiment of the invention in which the substrate 18 comes in the form of a compact block 28 that consists of an insoluble inner part 20 and a soluble outer part 22 that have a different coloring from that of the inner part 20 and that contain at least one active ingredient.

Compact block is defined as a powder agglomerate or a homogeneous block that consists of a continuous polymer.

The compact block 28 is preferably a quick-dissolving tablet or a lyophilizate.

The compact block 28 is manufactured and then arranged inside the tubular body and when a liquid passes inside the device 10, the outer layer 22 that contains the active ingredient dissolves. The surface can be increased by the presence of contours at the periphery.

A third embodiment is shown in diagram form in FIG. 7. The substrate 18 is an inner coating 32 with a tubular section that comprises several layers, arranged on the walls 12. The neutral substrate 20 is directly in contact with the walls of the tubular body or corresponds to the walls of the tubular body. It is covered by a soluble layer 22 that contains at least one active ingredient, able to be in contact with a liquid that circulates inside the device 10, having a color that is different from that of the neutral substrate 20.

According to a fourth embodiment that is simple to produce, shown in FIG. 10A, the substrate 18 also forms the nonreturn valve 16 or is arranged on the nonreturn valve 16. The device 10 has a lower tubular section that gradually narrows toward the end 14 and also comprises upper locking means 34 of the ball 16.

Preferably, the nonreturn valve 16 comes in the form of a high-density ball, comprising an insoluble, neutral inner substrate 20 and a soluble, outer coating layer 22 that has a different coloring from that of the neutral substrate 20 and that contains at least one active ingredient.

In this particular case, because of the lower tubular section that gradually narrows toward the end, once the outer layer 22 is dissolved, the small-diameter ball still plays its role as valve.

Advantageously, the device according to the invention makes it possible to administer an exact and reproducible dose of medication in easily absorbable liquid form.

When a patient sucks in a liquid, such as water or milk, for example, through the device 10 according to the invention, the medicinal outer layer 22 dissolves and is gulped down by the patient with the liquid. The insoluble neutral substrate 20 remains in the container.

Advantageously, since the substrate 20 and the outer layer 22 have a different color, when the entire active ingredient is dissolved and therefore absorbed by the patient, the container according to the invention changes color. It thus is possible to visualize the taking of the dispensed medication. This indicator makes it possible to ensure that the necessary dose has been duly administered while preventing the patient from drinking an excessive quantity of liquid.

In addition, the presence of the nonreturn valve 16 makes it possible to prevent an undetermined fraction of dissolved active ingredient from escaping into the glass that contains the dissolution liquid. It thus is possible to monitor exactly the quantity of active ingredient ingested by the patient.

In FIGS. 10B to 10F, the different stages of use of a particular embodiment of the invention are shown in diagram form. In this embodiment, the substrate 18 is arranged on the nonreturn valve 16 that has the shape of a ball.

First of all, the user arranges the device 10 in a liquid-filled glass and sucks in via the suction spout 35. The negative pressure that is produced in the circular tube makes the ball 16 rise, which releases the intake means 14 and allows the liquid to rise through the device. The outer layer 22 that is arranged on the ball 16 then dissolves, and the active ingredient that is dissolved in the liquid is gulped down by the patient. If the patient stops sucking, the ball 16 will drop back, thus keeping any of the dissolved active ingredient that is not gulped down from going back into the glass. The patient can then suck again until there is a change in color indicating that the entire active ingredient has been gulped down.

The device according to the invention therefore makes it possible to administer a medication easily to a patient, in particular to an elderly person or to a child, while monitoring the dispensing of the medication.

For example, if the soluble outer layer 22 has an orange-yellow neutral coloring and the inner substrate 20 has a green coloring, during the use of the product, the orange-yellow-colored outer layer that contains the active ingredient gradually dissolves and allows the underlying green coloring to appear. When the substrates 18 and therefore the device 10 become completely green, this means that the entire medicinal active ingredient has dissolved and that it has been absorbed by the patient.

At present, the invention is illustrated by manufacturing examples of the first embodiment of the invention.

### EXAMPLE 1

### Particles with a Yellow/Green Color Change

In this example, the device 10 according to the invention comprise substrates 18 in the form of particles, whereby each particle consists of a green, insoluble neutral inner substrate 20, a colorless, insoluble intermediate layer 23, and a yellow, outer coating layer 22.

The composition of the different layers is presented in the table below:

| | Component | Quantities |
|---|---|---|
| (Green, Water-Insoluble) | 2 mm Neutral Granule | 1 g |
| Inner Neutral Substrate | Green Lamination Solution | 0.034 g |
| | OPADRY 2 Green | |
| (Colorless, Water- | Ethyl Cellulose | 0.3 g |
| Insoluble) Intermediate | | |
| Layer | | |
| (Yellow - Water-Soluble) | Paracetamol | 0.150 g |
| Coating Layer | Saccharose | 1.600 g |
| | Povidone | 0.045 g |
| | Talc | 0.520 g |
| | Curcuma E100 Dye | 0.060 g |
| | Cranberry Flavor | 0.050 g |

The device can be prepared according to the process that is described below.

### Stage 1: Preparation of the Green Neutral Substrate

500 g of purified water, and then, while being stirred, 75 g of the OPADRY II Green®-type ready-to-use laminating agent (hypromellose, talc, polydextrose, maltodextrin, FD&C blue lacquer, quinoline yellow lacquer, titanium dioxide, triglyceride) are introduced into a 1-liter stainless steel tank. The preparation is stirred using a stirring mechanism with a deflocculant propeller until a preparation is obtained that comes in the form of a homogeneous viscous green suspension.

### Stage 2: Deposition of the Green Neutral Substrate

1,000 g of neutral saccharose granules that are 2 mm in diameter is introduced into a granulator with a fluidized-air bed.

The air flow is adjusted to put the particles in suspension and to put the temperature of the intake air at +60° C.+/−10° C.

The spraying of the green lamination solution prepared in stage 1 is begun, and the deposition of the solution is continued to obtain a granule mass of 1.230 kg.

### Stage 3: Preparation of the Insoluble Neutral Solution

600 ml of purified water, and then, while being stirred, 400 g of ethyl cellulose in the form of an aqueous dispersion (equivalent to 100 g of dry material, introduced in the form of Surealease Clear®) are introduced into a 1,000 ml stainless steel tank. The preparation is stirred until a homogeneous preparation is obtained.

### Stage 4: Deposition of an Insoluble Colorless Film

In the granulator with a fluidized-air bed that contains the green-colored granules (1.230 kg), the air flow is regulated to put the particles in suspension and to put the intake air temperature at +60° C.+/−10° C.

The insoluble, colorless varnish solution for lamination that is prepared in stage 3 is sprayed, and the deposition of the solution is continued to obtain a granule weight of 1.330 kg.

### Stage 5: Preparation of the Tinted Medicinal Solution

258 ml of purified water is introduced into a 1-liter stainless steel tank.

While being stirred, the various components are introduced chronologically:

| | |
|---|---|
| Paracetamol | 37.50 g |
| Saccharose | 400.00 g |
| Povidone | 11.25 g |
| Talc | 129.00 g |
| Curcuma E100 Dye | 14.70 g |
| Cranberry Flavor | 12.54 g |

The solution is stirred until a homogeneous suspension is obtained.

The preparation is filtered on a filter with a 0.1 mm mesh opening for ensuring complete dispersion of the materials in suspension.

### Stage 6: Deposition of the Tinted Medicinal Layer

In the granulator with a fluidized-air bed that contains green-colored granules with insulating varnish, the air flow is regulated to put the particles in suspension and to put the intake air temperature at +60° C.+/−10° C.

The prepared solution is deposited to obtain the tinted medicinal granules.

### Stage 7: Filling the Straws

A nonreturn valve plug 16 is introduced into the distal portion of the pipe, and then the straws are filled with the quantity of tinted particles for obtaining the suitable medicinal dosage.

The straw is closed with an intake spout 35.

### EXAMPLE 2

### Particles with a Red/Green Color Change

In this example, the device 10 according to the invention comprises substrates 18 in the form of particles, whereby each particle consists of a green, insoluble, neutral inner substrate 20, a colorless, insoluble intermediate layer 23, and a red, outer coating layer 22.

The composition of the various layers is presented in the table below:

| | Component | Quantities |
|---|---|---|
| (Green - Water-Insoluble) | 2 mm Neutral Granule | 1 g |
| Inner Neutral Substrate | Green Lamination Solution | 0.034 g |
| | OPADRY 2 Green | |
| (Colorless, Water- | Ethyl Cellulose | 0.3 g |
| Insoluble) Intermediate | | |
| Layer | | |
| (Red - Soluble) | Ibuprofen | 0.100 g |
| Coating Layer | Saccharose | 1.600 g |
| | Povidone | 0.045 g |
| | Talc | 0.520 g |
| | Aspartame | 0.050 g |
| | E120 Dye | 0.060 g |
| | Strawberry Flavor | 0.050 g |

### EXAMPLE 3

### Particles with a Red/White Color Change

In this example, the device 10 according to the invention comprises substrates 18 in the form of particles, whereby each particle consists of a colorless, insoluble neutral inner substrate 20 and a red, outer coating layer 22.

The composition of the different layers is presented in the table below:

| | Component | Quantities |
|---|---|---|
| (Colorless - Water- | Ethyl Cellulose | 0.3 g |
| Insoluble) Inner Neutral | Titanium Dioxide | 0.05 g |
| Substrate | | |
| (Red - Water-Soluble) | Ibuprofen | 0.100 g |
| Coating Layer | Saccharose | 1.600 g |
| | Povidone | 0.045 g |
| | Talc | 0.520 g |
| | Aspartame | 0.050 g |
| | E120 Dye | 0.060 g |
| | Strawberry Flavor | 0.050 g |

Of course, the invention obviously is not limited to the examples that are shown and described above, but on the contrary covers all of the variants.

1. Device (10) for oral administration of medications that comes in the form of an elongated tubular body, comprising means (12, 14) that can enable a liquid to enter or exit at each end, characterized in that it comprises a nonreturn valve (16) at one of the two ends and at least one substrate (18) that consists of at least one neutral substrate (20) and a soluble coating layer (22) that contains at least one active ingredient and that has a different coloring from that of the neutral substrate.

2. Device (10) for oral administration of medications according to claim 1, wherein the soluble layer (22) is tinted.

3. Device (10) for oral administration of medications according to claim 1, wherein the neutral substrate (20) is tinted.

4. Device (10) for oral administration of medications according to claim 1, wherein the neutral substrate (20) is insoluble.

5. Device (10) for oral administration of medications according to claim 4, wherein the neutral substrate (20) comprises a polyethylene or polypropylene plastic polymer, an opacifying agent, and optionally a coloring agent.

6. Device (10) for oral administration of medications according to claim 4, wherein the neutral substrate (20) comprises balls of saccharide, polysaccharide or agar-agar-type gelling agent or starch, an opacifying agent, and optionally a coloring agent.

7. Device (10) for oral administration of medications according to claim 4, wherein the neutral substrate (20) comprises a mixture of gelatin, glycerin, and optionally a coloring agent.

8. Device (10) for oral administration of medications according to claim 1, wherein the substrate (18) comprises an insoluble layer (23) between the neutral substrate (20) and the outer layer (22).

9. Device (10) for oral administration of medications according to claim 8, wherein the layer (23) is tinted with a color that is different from that of the outer layer (22).

10. Device (10) for oral administration of medications according to claim 1, wherein the outer layer (22) comprises at least one active ingredient, a diluting agent, a neutral feedstock agent, a binding agent, povidone, and optionally a coloring agent.

11. Device (10) for oral administration of medications according to claim 1, wherein the outer layer (22) comprises at least one active ingredient, a solubilizing agent, and optionally a coloring agent.

12. Device (10) for oral administration of medications according to claim 1, wherein the outer layer (22) comprises a coloring agent that comes in the form of an aluminum lacquer.

13. Device (10) for oral administration of medications according to claim 1, wherein it comprises several substrates (18) that come in the form of particles (24), whereby each particle (24) comprises a neutral inner substrate (20), and at least one soluble outer coating layer (22) that contains at least one active ingredient and that has a different coloring from that of the neutral substrate (20).

14. Device (10) for oral administration of medications according to claim 13, wherein the particle is between 0.8 and 4 mm in size.

15. Device (10) for oral administration of medications according to claim 1, wherein the substrate (18) comes in the form of a compact block (28) that consists of a neutral inner part (30), and at least one soluble, outer coating layer (32) that contains at least one active ingredient and that has a different coloring from that of the neutral part (30).

16. Device (10) for oral administration of medications according to claim 1, wherein the substrate (18) is a coating (32) that consists of at least one neutral substrate (20) that corresponds to the walls of the device (10) or is arranged on the walls of the device (10), and a soluble coating layer (22) that contains at least one active ingredient and that has a different coloring from that of the neutral substrate.

17. Device (10) for oral administration of medications according to of claim 1, wherein the substrate (18) also forms the nonreturn valve (16) or is arranged on the nonreturn valve (16).

18. Device (10) for oral administration of medications according to claim 1, wherein the nonreturn valve (16) is a ball.

19. Device (10) for oral administration of medications according to claim 1, wherein it comprises means (34) for locking the nonreturn valve (16).

20. Device (10) for oral administration of medications according to claim 1, wherein it comes in the form of an elongated tubular body with a section that decreases toward one of the two ends.
